(19) United States
(12) Patent Application Publication
(10) Pub. No.: US 2004/0237361 A1
(43) Pub. Date: Dec. 2, 2004

(54) Card with glued-in translucent insert and method for making same

(75) Inventor: Michael T. Adams, Lee's Summit, MO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hallmark Cards, Incorporated, Kansas City, MO

(21) Appl. No.: 10/869,253

(22) Filed: Jun. 15, 2004

Related U.S. Application Data
(63) Continuation of application No. 09/641,251, filed on Aug. 17, 2000, now abandoned.

(51) Int. Cl. G09F 1/00

(52) U.S. Cl. 40/124.191

(57) ABSTRACT

A card with a glued-in translucent insert is made by applying to a sheet of card stock an adhesive layer in decorative pattern and adhering a sheet of translucent insert stock to the adhesive layer. The decorative pattern of the adhesive layer shows through the translucent insert stock to form a design element of the card.

### CROSS-REFERENCES TO RELATED APPLICATIONS

This application is a continuation and claims benefit of application Ser. No. 09/641,251 filed Aug. 17, 2000.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates generally to the field of cards, such as social expression cards, invitations, and the like, and more particularly to a method of making aesthetically pleasing cards with glued-in translucent inserts.

Cards, such as social expression cards, announcements, invitations, and the like, are produced in many styles. One popular card style is the insert card, which includes a backing of card stock having a translucent insert page glued thereto. Examples of material used for translucent inserts include Canson (TM), Gildclear (TM) or simulated parchment.

Insert pages are glued by hand to the card stock 20 backing. A worker applies a line or one or more spots of glue to the card stock backing and then adheres the insert page to the glue spots or line. The current method of making insert cards usually results in non uniform, often unsightly, glue marks that show through the translucent insert. The appearance of the glue marks is amplified on darker colored stocks.

Card manufacturers rely on the skill of the workers to minimize the unsightly effects of the current gluing process. However, even with skilled workers, a substantial number of cards are scrapped for poor quality glue appearance. An alternative to relying on the skill of the workers is to hide the glue behind printed design features of the insert page. However, neither solution to the problem of glue spots is entirely satisfactory.

It is an object of the present invention to provide a method of producing cards with glued in inserts that overcomes the shortcomings of the prior art.

### SUMMARY OF THE INVENTION

The present invention provides a card with a glued in translucent insert and a method of making same. The card of the present invention is made by applying to a sheet of card stock an adhesive layer in a decorative pattern and adhering a sheet of translucent insert stock to the adhesive layer. The decorative pattern of the adhesive layer shows through the translucent insert stock to form a design element of the card.

The adhesive layer is preferably applied using a 15 printing process, such as screen printing. The adhesive of the adhesive layer may be transparent, colorless, or colored. The card stock may be colored so that the color of the card stock is transmitted by the adhesive through the translucent insert.

### BRIEF DESCRIPTION OF THE DRAWINGS

FIG. 1 is a view of one embodiment of a card according to the present invention.

FIG. 2 is a view of a second embodiment of a card 25 according to the present invention.

FIG. 3 is process flow diagram of the method of the present invention.

### DETAILED DESCRIPTION OF THE INVENTION

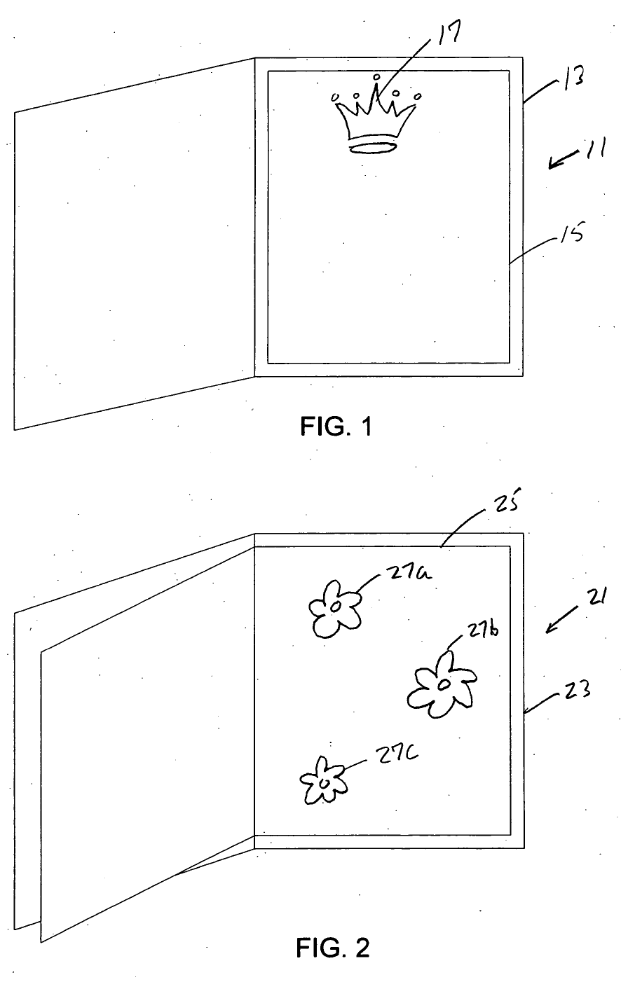

Referring now to the drawings, and first to FIG. 1, a card according to the present invention is designated generally by the numeral 11. Card 11 includes a folded sheet of card stock 13 and an insert 15 of a translucent paper material covering the right inside panel of card stock 13. Examples of translucent materials used in cards according to the present invention include Canson (TM), Gildclear (TM) and simulated parchment.

According to the present invention, insert 15 is adhered to cardstock 13 by a layer of adhesive applied to cardstock 13 in a decorative pattern. In FIG. 1, the adhesive layer is applied in the form of a crown 17. The adhesive may be transparent, colorless, or colored. In the case of transparent and colorless adhesives, the color of cardstock 13 shows through the adhesive layer and insert 15 causing the decorative pattern of the adhesive layer to show through insert 15. In the case of colored adhesives, the color of the adhesive shows through insert 15. The decorative pattern is selected and positioned so as to form a design element of card 11. Insert 15 may be printed with an expression, as is well known to those skilled in the art.

Referring now to FIG. 2, an alternative card 20 according to the present invention is designated generally by the numeral 21. Card 21 includes a folded sheet of card stock 23 and a folded translucent insert 25. In the embodiment of FIG. 2, insert 25 covers both inside panels of sheet 23. Insert 25 is adhered to cardstock 23 by layers of adhesive applied to the right inside panel of sheet 23. In the embodiment of FIG. 2, the adhesive layers are applied in the form of fanciful floral designs 27. Again, the adhesive layers show through insert 25 to form design elements of card 21.

It should be apparent that the adhesive layer or layers may be applied in other decorative designs besides those illustrated with respect to FIGS. 1 and 2. For example, the adhesive may be applied in geometric or abstract patterns according the imagination and artistic talent of the designer. The method of the present invention gives the designer an additional element to use in creating new and interesting cards.

Preferably, the adhesive layers are applied using a 5 printing process such as stenciling or screen printing.

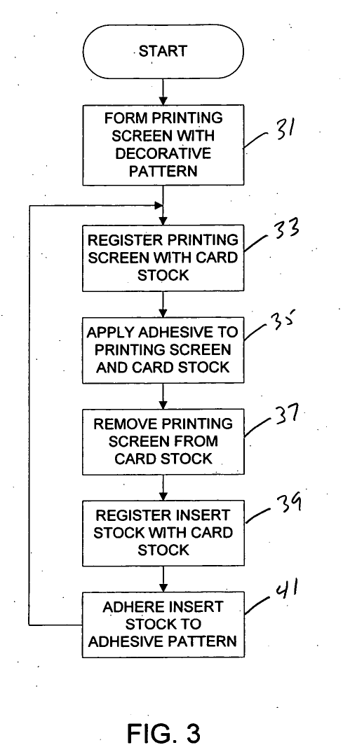

Referring to FIG. 3, there is shown a process flow diagram of a preferred embodiment of the method according to the present invention. A printing screen is formed with a decorative pattern, at block 31, using well known printing screen preparation techniques. After forming the printing screen, the printing screen is registered with the card stock, at block 33, and a suitable adhesive is applied to the screen and card stock, at block 35. An example of a suitable adhesive is cold applied glue. The adhesive may be transparent, colorless, or colored, depending upon the effect that the card designer desires. After applying the adhesive to the printing screen and card stock, the printing screen is removed from the card stock, at block 37. Then, the insert is registered with the card stock, at block 39, and adhered to the adhesive pattern, at block 41. Steps 33 through 41 may be repeated to make multiple cards.

From the foregoing, it may be seen that the method of the present invention produces a card that overcomes the shortcomings of the prior art. The method of the present invention not only solves the appearance issues but also gives designers an additional design element with which they may work. Since the glue can be applied in a pattern, it adds to the overall design of the card rather than detracting through poor aesthetic quality. Moreover, the process of the present invention reduces not only the required skill level needed in hand assembly but also the amount of operator spoilage and waste.

The present invention has been illustrated and described with respect to presently preferred embodiments. Those skilled in the art, given the benefit the foregoing disclosure, appreciate alternative forms and embodiments of the card and method of the present invention. Accordingly, the foregoing description is intended for purposes of illustration and not of limitation.

What is claimed is:

1. A method of making a card, which comprises the steps of:
applying to a sheet of card stock an adhesive in a decorative pattern; and,
adhering a sheet of translucent insert stock to said adhesive whereby said adhesive transmits said decorative pattern through said translucent insert stock.

2. The method as claimed in claim 1, wherein said step of applying said adhesive includes the step of:
printing said adhesive onto said card stock.

3. The method as claimed in claim 2-, wherein said step of printing said adhesive onto said card stock is performed using a screen printing process.

4. The method as claimed in claim 1, wherein said step of applying said adhesive includes the steps of:
forming printing screen with said decorative pattern; and,
using said printing screen to apply said adhesive to said card stock.

5. The method as claimed in claim 1, wherein said decorative pattern forms a design element of said card.

6. The method as claimed in claim 1, wherein said sheet of card stock is colored and said adhesive transmits the color of said card stock through said sheet of translucent insert stock.

7. The method as claimed in claim 6, wherein said adhesive is substantially transparent.

8. The method as claimed in claim 6, wherein said adhesive is substantially colorless.

9. The method as claimed in claim 1, wherein said adhesive is colored.

10. The method as claimed in claim 1, wherein said sheet of card stock is substantially opaque.

11. A method of making a card, which comprises the steps of:
forming a printing screen for printing a pattern;
using said printing screen to apply an adhesive layer in 5 said pattern to one of a sheet of card stock and a sheet of translucent insert stock;
registering said sheet of translucent insert stock with said sheet of card stock; and,
forcing the other of said sheet of registered translucent insert stock and said card stock into adhering contact with said adhesive pattern, whereby said pattern is transmitted through said insert stock.

12. The method as claimed in claim 11, wherein said printing screen is used to apply said adhesive to said sheet of card stock.

13. The method as claimed in claim 11, wherein said pattern forms a design element of said card.

14. The method as claimed in claim 11, wherein said sheet of card stock is colored and said adhesive transmits the color of said card stock through said sheet of translucent insert stock.

15. The method as claimed in claim 14, wherein said adhesive is substantially transparent.

16. The method as claimed in claim 14, wherein said adhesive is substantially colorless.

17. The method as claimed in claim 11, wherein said adhesive is colored.

18. The method as claimed in claim 1, wherein said sheet of card stock is substantially opaque.

19. A card, which comprises:
a sheet of card stock;
a sheet of translucent insert stock overlying at least a portion of said sheet of card stock; and,
a decorative layer of adhesive disposed between and adhered to each of said sheet of colored card stock and said sheet of translucent insert stock, whereby a decorative pattern formed by said adhesive layer is transmitted to said translucent insert stock.

20. The card as claimed in claim 19, wherein said decorative pattern forms a design element of said card.
